(19) United States
(12) Patent Application Publication
(10) Pub. No.: US 2026/0270264 A1
(43) Pub. Date: Sep. 10, 2026

(54) NETWORK VERIFICATION OF USER EQUIPMENT (UE) IDENTIFIER REQUEST MADE BY EDGE CLIENT

(71) Applicant: Telefonaktiebolaget LM Ericsson (publ), Stockholm (SE)

(72) Inventors: Wenliang XU, Shanghai (CN); Ferhat KARAKOC, Shanghai (CN)

(73) Assignee: Telefonaktiebolaget LM Ericsson (publ), Stockholm (SE)

(21) Appl. No.: 19/472,093

(22) PCT Filed: Apr. 8, 2024
(86) PCT No.: PCT/EP2024/059460

§ 371 Date: Oct. 2, 2025

(30) Foreign Application Priority Data
Apr. 7, 2023 (CN) PCY/CN2023/086773

(51) Int. Cl. H04L 9/40; H04L 61/5007

(52) U.S. Cl. CPC H04L 63/10; H04L 61/5007; H04L 63/0876

(57) ABSTRACT

Embodiments include methods for a client (e.g., EEC) of an edge data network coupled to a communication network. Such methods include sending, to a server of the edge data network, a request for an identifier of a user equipment (UE) that hosts the client. The request includes an IP address assigned to the UE by the communication network and a verification parameter indicating that the client is authorized to request a UE identifier (UE ID) associated with the IP address. Such methods also include subsequently receiving the requested UE ID from the server, based on successful verification of the verification parameter by the communication network. Other embodiments include complementary methods for the server, a network exposure function (NEF) of the communication network, and a verification server of the communication network, as well as clients, servers, NEFs, and verification servers configured to perform such methods.

### TECHNICAL FIELD

The present application relates generally to the field of wireless communication networks, and more specifically to techniques for improving security in edge data networks by verifying edge client requests for identifiers of user equipment (UE) that host edge clients.

### BACKGROUND

Currently the fifth generation (5G) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation RAN (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. A gNB-CU 110 connects to one or more gNB-DUs 120, 130 over respective F1 logical interfaces, such as interfaces 122 and 132 shown in FIG. 1. However, a gNB-DU 120, 130 can be connected to only a single gNB-CU 110. The gNB-CU 110 and connected gNB-DU(s) 120, 130 are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services. This SBA model also adopts principles like modularity, reusability, and self-containment of NFs, which can enable deployments to take advantage of the latest virtualization and software technologies.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow NFs to discover services offered by other NFS, and network exposure functions (NEF) securely expose NF capabilities and events to application functions (AFs) outside of the 5GC.

It is expected that 5GC will support edge computing (EC), which enables operator and third-party services to be hosted close to a UE's access point of attachment. EC can facilitate efficient service delivery through reduced end-to-end latency and load on the transport network.

3GPP TR 33.839 (v17.1.0) discusses a study on security aspects for supporting EC in 5GC for Rel-17. Key issues discussed in 3GPP TR 33.839 include authentication, authorization, and transport security solutions for interfaces between clients and servers and for interfaces between different servers in an Edge data network. These servers can include Edge Configuration Servers (ECS), Edge Enabler Servers (EES), and Edge Application Servers (EAS). Relevant clients include Edge Enabler Client (EEC), which can be regarded an application that runs on the UE and communicates with the ECS and EES. 3GPP TS 23.558 (v17.3.0) specifies an architecture for enabling EC applications, which includes these clients and servers.

3GPP TS 23.502 (v17.8.0) sections 4.15.10 and 5.2.6.27 describe an NEF service Nnef_UEId that can be used to support EC use cases. In particular, this service is used to translate a UE's IP address to an AF-specific external identifier, which is a type of generic public subscription identifier (GPSI) that can be used to identify a UE subscription outside of a 3GPP network. For example, an EES can invoke this NEF service to obtain the AF-specific external identifier corresponding to the UE's IP address.

Even so, network/port address translation (NAT) may cause difficulties for this NEF service. For example, NAT is often used in cloud deployments (including for EC) to translate multiple IP addresses and/or port numbers internal to a network to a single public IP address. Thus, when there are multiple UEs (or EECs) operating within the edge infrastructure, the NEF will be unable to map the single public IP address to individual UE external identifiers.

3GPP TR 23.700-98 (v18.0.0) describes a study on architecture enhancements needed to enable EC applications in 3GPP networks, and identifies this issue of how EES can access 3GPP network services pertaining to a UE when the edge data network employs NAT. 3GPP TR 23.700 identifies a “solution #23” to this issue, whereby the UE's EEC provides the private IP address (received from the network) to the EES, which uses this address to invoke the NEF Nnef_UEId service and obtain the AF-specific UE external identifier of the UE.

Solution #23 relies on the EEC to provide its own private IP address to the EES. However, by sending the EES another private IP address instead of its own, a malicious EEC can learn AF-specific external identifiers for other UEs. Thus, the security of the current solution is inadequate.

### SUMMARY

An object of embodiments of the present disclosure is to improve security of EC deployments by addressing these and other problems, issues, and/or difficulties, thereby facilitating the otherwise-advantageous deployment of EC solutions in 5G networks.

Some embodiments of the present disclosure include methods (e.g., procedures) for a client (e.g., EEC) of an edge data network coupled to a communication network (e.g., 5G network).

These exemplary methods can include sending, to a server of the edge data network, a request for an identifier of a UE that hosts the client. The request includes an IP address assigned to the UE by the communication network and a verification parameter indicating that the client is authorized to request a UE identifier (UE ID) associated with the IP address. These exemplary methods can also include subsequently receiving the requested UE ID from the server, based on successful verification of the verification parameter by the communication network.

In some embodiments, these exemplary methods can also include receiving the assigned IP address from the communication network during establishment of a protocol data unit (PDU) session for the client. In some of these embodiments, these exemplary methods can also include computing the verification parameter based on one or more of the following: the received IP address, a security key known or derivable by the UE and by the communication network, and a message authentication code (MAC) algorithm.

In other of these embodiments, the verification parameter is received from the communication network together with the assigned IP address. In some variants of these embodiments, the verification parameter is a randomly generated nonce value.

In some embodiments, the client is an EEC and the server is an EES. In some embodiments, the UE ID is a GPSI or an Edge UE ID.

Other embodiments include complementary methods (e.g., procedures) for a server (e.g., EES) of an edge data network coupled to a communication network (e.g., 5G network).

These exemplary methods can include receiving, from a client in the edge data network, a request for an identifier of a UE that hosts the client. The request includes an IP address assigned to the UE by the communication network and a verification parameter indicating that the client is authorized to request a UE identifier (UE ID) associated with the IP address. These exemplary methods can also include sending a further request for the UE ID to a network exposure function (NEF) of the communication network. The further request includes the received IP address, the received verification parameter, and an identifier of the server. These exemplary methods can also include subsequently receiving the requested UE ID from the NEF, based on successful verification of the verification parameter by the communication network, and sending the UE ID to the client.

In some embodiments, the verification parameter is based on one or more of the following: the IP address, a security key known or derivable by the UE and by the communication network, and a MAC algorithm. In other embodiments, the verification parameter is a randomly generated nonce value. In some embodiments, the client is an EEC and the server is an EES. In some embodiments, the UE ID is a GPSI or an Edge UE ID.

Other embodiments include complementary methods (e.g., procedures) for a NEF of a communication network (e.g., 5G network) coupled to an edge data network.

These exemplary methods can include receiving, from a server of the edge data network, a request for an identifier of a UE that hosts a client of the server. The request includes an IP address assigned to the UE by the communication network, a verification parameter indicating that the client is authorized to request a UE identifier (UE ID) associated with the IP address, and an identifier of the server. These exemplary methods can also include, based on the identifier of the server, determining that the server is authorized to request the UE ID.

These exemplary methods can also include, based on determining that the server is authorized, sending the IP address and the verification parameter to a verification server of the communication network. These exemplary methods can also include receiving an indication that the verification server successfully verified the verification parameter and in response to the indication, obtaining the UE ID from a data repository of the communication network based on the IP address. These exemplary methods can also include sending the UE ID to the server in response to the request.

In some embodiments, the verification parameter is based on one or more of the following: the IP address, a security key known or derivable by the UE and by the communication network, and a MAC algorithm. In different variants of these embodiments, the security key is one of the following: Kausf, a key directly or indirectly derivable from Kausf, Kamf, or a key directly or indirectly derivable from Kamf. In other embodiments, the verification parameter is a randomly generated nonce value.

In some embodiments, the client is an EEC and the server is an EES. In some embodiments, the UE ID is a GPSI or an Edge UE ID. In some embodiments, the data repository is a unified data management function (UDM) of the communication network. In different embodiments, the verification server is a binding support function (BSF) or an authentication server function (AUSF).

Other embodiments include complementary methods (e.g., procedures) for a verification server of a communication network (e.g., 5GC) coupled to an edge data network.

These exemplary methods can include receiving, from an NEF of the communication network, a request to authorize retrieval of an identifier of a UE that hosts a client of a server in the edge data network. The request includes the verification parameter and an IP address assigned to the UE by the communication network. These exemplary methods can also include determining that a match exists between the verification parameter and a corresponding verification parameter that is accessible to the verification server. These exemplary methods can also include, based on determining that the match exists, sending to the NEF an indication that the verification server successfully verified the verification parameter.

In some embodiments, these exemplary methods can also include receiving, from a policy control function (PCF) of the communication network, the assigned IP address during establishment of a PDU session for the client. In some of these embodiments, determining that a match exists between the verification parameter and a corresponding verification parameter includes computing the corresponding verification parameter based on one or more of the following: the assigned IP address, a security key known or derivable by the UE and by the communication network, and a MAC algorithm.

In some variants of these embodiments, the security key is received from the PCF together with the assigned IP address. In some variants of these embodiments, the verification server is an AUSF and the security key is Kausf or a key directly or indirectly derivable from Kausf. In other variants of these embodiments, the verification server is a BSF and the security key is Kamf or a key directly or indirectly derivable from Kamf.

In other of these embodiments, the verification parameter is received from the communication network together with the assigned IP address. In some variants of these embodiments, the verification parameter is a randomly generated nonce value.

In some embodiments, the client is an EEC and the server is an EES. In some embodiments, the UE ID is a GPSI or an Edge UE ID.

Other embodiments include clients, servers, NEFs, and verification servers that are configured to perform operations corresponding to various exemplary methods described herein. Other embodiments also include non-transitory, computer-readable media storing computer-executable instructions that, when executed by processing circuitry, configure such clients, servers, NEFs, and verification servers to perform operations corresponding to various exemplary methods described herein.

These and other embodiments described herein can prevent rogue or unauthorized UEs from obtaining UE identifiers for other UEs, which improves security in edge data networks coupled to 3GPP networks (e.g., 5GC and NG-RAN).

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows a diagram of an exemplary application-layer architecture supporting edge computing (EC) applications in a 5G network.

FIG. 4 shows a signaling diagram of a procedure for an EEC in a UE to obtain a UE ID from an EES.

FIGS. 5-8 show signaling diagrams of various procedures for IP address verification in a communication network, according to various embodiments of the present disclosure.

FIG. 9 shows an exemplary method (e.g., procedure) for a client of an edge data network, according to various embodiments of the present disclosure.

FIG. 10 shows an exemplary method (e.g., procedure) for a server of an edge data network, according to various embodiments of the present disclosure.

FIG. 11 shows an exemplary method (e.g., procedure) for a network exposure function (NEF) of a communication network, according to various embodiments of the present disclosure.

FIG. 12 shows an exemplary method (e.g., procedure) for a verification server of a communication network, according to various embodiments of the present disclosure.

FIG. 13 shows a communication system according to various embodiments of the present disclosure.

FIG. 14 shows a UE according to various embodiments of the present disclosure.

FIG. 15 shows a network node according to various embodiments of the present disclosure.

FIG. 16 shows a host computing system according to various embodiments of the present disclosure.

FIG. 17 is a block diagram of a virtualization environment in which functions implemented by some embodiments of the present disclosure may be virtualized.

FIG. 18 illustrates communication between a host computing system, a network node, and a UE via multiple connections, at least one of which is wireless, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the disclosed embodiments will be apparent from the following description.

Furthermore, the following terms are used throughout the description given below: Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.

Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like. Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.

Radio Node: As used herein, a “radio node” can be either a “radio access node” (or equivalent term) or a “wireless device.”

Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

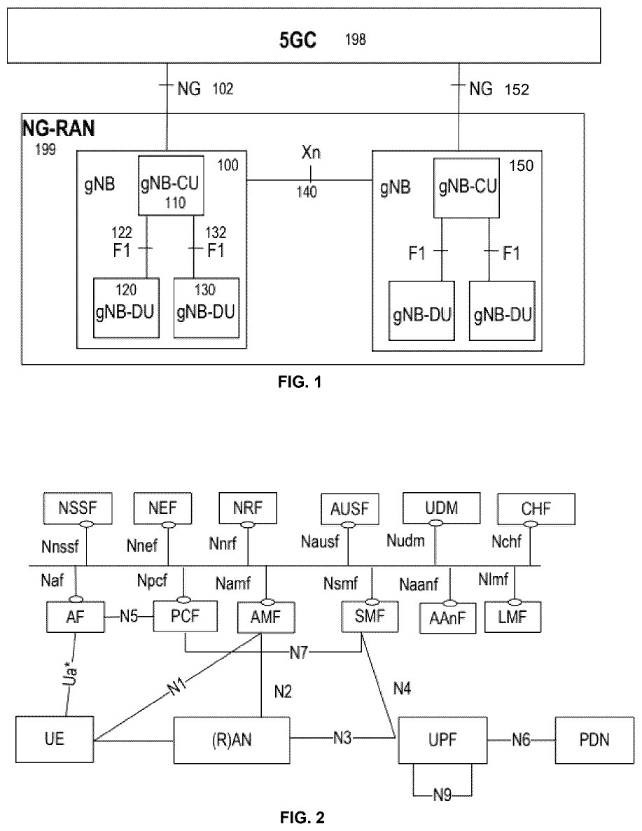

FIG. 2 shows an exemplary non-roaming 5G reference architecture with service-based interfaces and various 3GPP-defined NFs within the Control Plane (CP). These include the following NFs, with additional details provided for those most relevant to the present disclosure:

Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.

Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.

User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.

Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.

Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.

Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.

Network Exposure Function (NEF) with Nnef interface-acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.

Network Repository Function (NRF) with Nnrf interface-provides service registration and discovery, enabling NFs to identify appropriate services available from other NFs.

Network Slice Selection Function (NSSF) with Nnssf interface-a “network slice” is a logical partition of a 5G network that provides specific network capabilities and characteristics, e.g., in support of a particular service. A network slice instance is a set of NF instances and the required network resources (e.g., computing, storage, and communication) that provide the capabilities and characteristics of the network slice. The NSSF enables other NFs (e.g., AMF) to identify a network slice instance that is appropriate for a UE's desired service.

Authentication Server Function (AUSF) with Nausf interface-based in a user's home network (HPLMN), it performs user authentication and computes security key materials for various purposes.

Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

Unified Data Management (UDM) function with Nudm interface-supports generation of 3GPP authentication credentials, user identification handling, access authorization based on subscription data, and other subscriber-related functions. To provide this functionality, the UDM uses subscription data (including authentication data) stored in the 5GC unified data repository (UDR), which also supports storage and retrieval of policy data by the PCF, as well as storage and retrieval of application data by NEF.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3GPP Rel-16 introduces a new feature called authentication and key management for applications (AKMA) that is based on 3GPP user credentials in 5G, including the Internet of Things (IoT) use case. More specifically, AKMA leverages the user's AKA (Authentication and Key Agreement) credentials to bootstrap security between the UE and an application function (AF), which allows the UE to securely exchange data with an application server. The AKMA architecture is an evolution of Generic Bootstrapping Architecture (GBA) specified for 5GC in 3GPP Rel-15 and is further specified in 3GPP TS 33.535 (v16.1.0).

In addition to the NEF, AUSF, and AF shown in FIG. 2 and described above, Rel-16 AKMA also utilizes an anchor function for authentication and key management for applications (AAnF). This function is shown in FIG. 2 with Naanf interface. In general, AAnF interacts with AUSFs and maintains UE AKMA contexts to be used for subsequent bootstrapping requests, e.g., by application functions. At a high level, AAnF is similar to a bootstrapping server function defined for Rel-15 GBA.

In general, security mechanisms for various 5GS protocols rely on multiple security keys. 3GPP TS 33.501 (v16.4.0) specifies these keys in an organized hierarchy. At the top is the long-term key part of the authentication credential and stored in the SIM card on the UE side and in the UDM/ARPF in the user's HPLMN.

A successful Primary Authentication run between the UE and the AUSF in the HPLMN leads to the establishment of KAUSF, the second level key in the hierarchy. This key is not intended to leave the HPLMN and is used to secure the exchange of information between UE and HPLMN, such as for the provisioning of parameters to the UE from UDM in HPLMN. More precisely, KAUSF is used for integrity protection of messages delivered from HPLMN to UE. As described in 3GPP TS 33.501, such new features include the Steering of Roaming (SoR) and the UDM parameter delivery procedures.

KAUSF is used to derive another key, KSEAF, that is sent to the serving PLMN. This key is then used by the serving PLMN to derive subsequent NAS and AS protection keys. These lower-level keys together with other security parameters (e.g., cryptographic algorithms, UE security capabilities, value of counters used for replay protection in various protocols, etc.) constitute the 5G security context as defined in 3GPP TS 33.501. However, KAUSF is not part of the UE's 5G security context that resides in the UE's serving PLMN.

3GPP TR 33.839 (v17.1.0) discusses a study on security aspects of enhancement of support for Edge Computing (EC) in 5GC for 3GPP Rel-17. Key issues discussed in 3GPP TR 33.839 include authentication, authorization, and transport security solutions for interfaces between clients and servers and for interfaces between different servers in an Edge data network. These servers can include Edge Configuration Servers (ECS), Edge Enabler Servers (EES), and Edge Application Servers (EAS). Relevant clients include Edge Enabler Client (EEC), which can be regarded as an application that runs on the UE and communicates with ECS and EES.

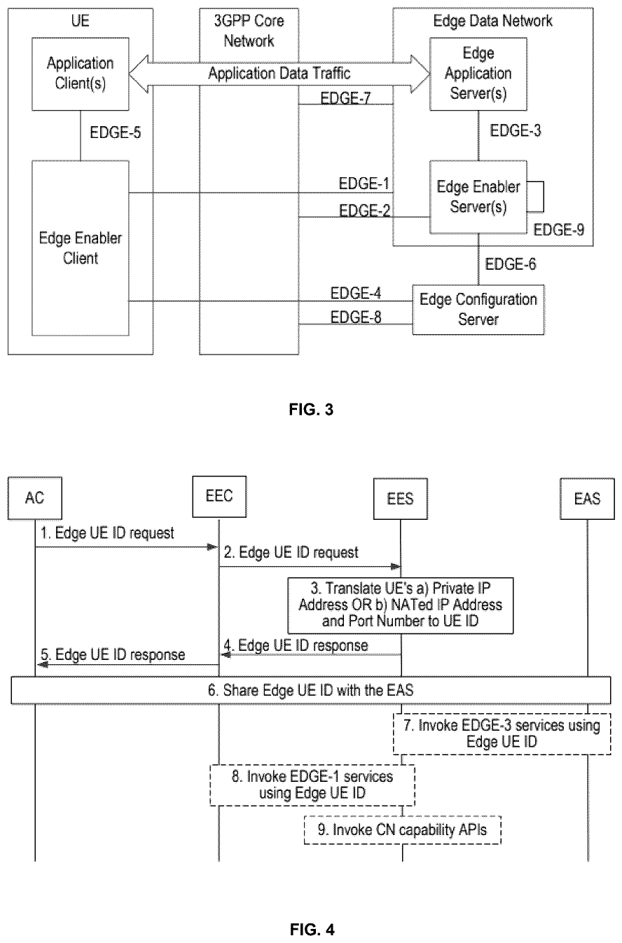

3GPP TS 23.558 (v17.3.0) specifies the various client/server and server/server interfaces in the Rel-17 EC architecture. FIG. 3 shows a diagram of an exemplary application-layer architecture supporting EC applications. In addition to the ECS, EES, EAS, and EEC mentioned above, FIG. 3 also shows one or more application clients that run on the UE and communicate application data traffic with the EAS in the Edge Data Network. Additionally, FIG. 3 shows the following client/server and server/server interfaces defined in 3GPP TS 23.558:
EDGE-1: between EEC and EES.
EDGE-2: between EES and CN (e.g., 5GC).
EDGE-3: between EAS and EES.
EDGE-4: between EEC and ECS.
EDGE-5: between EEC and application client(s).
EDGE-6: between ECS and EES.
EDGE-7: between EAS and CN.
EDGE-8: between ECS and CN.
EDGE-9: between EES and EES.

In the architecture shown in FIG. 3, the EEC, which runs on the UE, needs to authenticate itself towards to the EES/ECS. The EEC provides a UE identifier (ID) for this purpose, as specified in 3GPP TS 23.558 section 7.2.6. One example UE ID is the generic public subscription identifier (GPSI), which can be used inside and outside of 5G networks as further specified in 3GPP TS 23.501 (v17.2.0) and 23.003 (v17.3.0). 3GPP TS 23.558 also specifies an edge enabler layer that includes the UE's EEC. In this arrangement, the UE uses an EEC ID as the client identifier on the edge enabler layer.

3GPP TS 23.502 (v17.8.0) sections 4.15.10 and 5.2.6.27 describe an NEF service Nnef_UEId that can be used to support EC use cases. In particular, this service is used to translate a UE's IP address to an AF-specific external identifier, which is a type of GPSI that can be used to identify a UE subscription outside of a 3GPP network. For example, an EES can invoke this NEF service to obtain the AF-specific external identifier corresponding to the UE's IP address.

Even so, network/port address translation (NAT) may cause difficulties for this NEF service. For example, NAT is often used in cloud deployments (including for EC) to translate multiple IP addresses and/or port numbers internal to a network to a single public IP address visible to external networks. Thus, when there are multiple UEs (or EECs) operating within the edge data network, the NEF will be unable to map the single public IP address to individual UE external identifiers.

3GPP TR 23.700-98 (v18.0.0) describes a study on architecture enhancements needed to enable EC applications in 3GPP networks, and identifies this issue of how EES can access 3GPP network services pertaining to a UE when the edge data network employs NAT. 3GPP TR 23-700 identifies a “solution #23” to this issue, whereby the UE's EEC provides the private IP address (received from the network) to the EES, which uses this address to invokes the NEF Nnef_UEId service and obtain the AF-specific external identifier of the UE.

FIG. 4 shows a signaling diagram of a procedure for an EEC in a UE to obtain a UE ID from EES. In operation 1, an application client (AC) in the UE sends an Edge UE ID request to the EEC. The request may include the list of edge application server IDs (EASIDs) for which the AC is requesting the Edge UE ID information. In operation 2, upon receiving the request the EEC validates if AC is authorized to request this information. If AC is authorised, the EEC sends the Edge UE ID request to the EES. The request includes either the CN assigned private IP address of the UE or its UE ID (if it already has one) and may include the list of EASIDs if provided by the AC.

Note that EEC can also send the request in operation 2 without receiving a request from AC in operation 1. Additionally, the same or different private IP addresses can be used by AC and EEC (e.g., if different PDU sessions are used). The request from EEC in operation 2 can include either of these IP addresses.

In operation 3, Upon receiving the request from EEC, the EES authorizes the EEC. If authorized and the UE ID is not included in the request the EES invokes the CN capability APIs. There are three alternate approaches:
1. EES invokes Nnef_UEId_Get for translating the UE's Private IP address to its UE ID as defined in 3GPP TS 23.502 section 4.15.10. If the request from EEC includes a list of EASIDs, the EES may invoke the Nnef_UEId_Get API for each EAS individually to obtain EAS specific UE ID(s); or
2. EES invokes the CN capability APIs for translating UE's NAT′d IP Address and the port number to its UE ID. Optionally, EAS may also provide UE's NAT′d IP address and port number to EES to obtain UE ID; or
3. EES invokes the CN capability APIs for translating UE's EECID to its UE ID.

In the second and third options, the request from EEC in operation 2 may not include UE's Private IP address. In any case, the EES generates temporary Edge UE ID(s) which may be the same as the 3GPP CN provided UE ID or may be assigned by the EES itself. If UE ID is included in the request received from EEC, the EES generates temporary Edge UE ID. The temporary Edge UE ID may be specific for the EASs included in request received from EEC in operation 2, in which case upon receiving a request on EDGE-3 interface, the EES matches the EASID in the request with EASIDs to which the Edge UE ID was assigned before processing the request.

In operation 4, EES sends the Edge UE ID response to the EEC including the Edge UE ID(s). In operation 5, upon receiving the response from EES, EEC provides the Edge UE ID information to the AC by sending the Edge UE ID response. In operation 6, the AC provides the Edge UE ID information to the EAS, which may be done in an implementation-specific manner. In operation 7, EAS uses the received Edge UE ID to invoke the APIs provided by the EES over EDGE-3 interface (e.g., T-EAS Discovery, UE location request, ACR request, and EELManangedACR services).

In operation 8, the EEC uses the received Edge UE ID to invoke API provided by the EES over EDGE-1 interface (e.g., EAS Discovery and ACR request services). In operation 9, the EES uses the UE ID received from the EEC (or obtained from CN in operation 3) to invoke the 3GPP CN capabilities as described in 3GPP TS 23.558 section 8.10.3. This operation can be performed following triggers that require 3GPP CN capabilities to be invoked (e.g., on receiving a request over EDGE-1 or EDGE-3), in which case, to invoke the 3GPP CN capabilities the EES uses the UE ID associated with the Edge UE ID included in the trigger.

Solution #23 relies on the EEC to provide its own private IP address to the EES. However, by sending the EES another private IP address instead of its own, a malicious EEC can learn AF-specific external identifiers for other UEs. Thus, the security of the current solution is inadequate.

Embodiments of the present disclosure address these and other problems, issues, and/or difficulties by providing techniques for IP address verification in UE ID application programming interface (API). In some embodiments, The 3GPP network provides an additional parameter in addition to the private IP address for verification of the correctness of the private IP address in the Nnef_UEId service invocation. In other embodiments, the UE generates an IP address verification parameter and shares this verification parameter and the IP address with the EEC, which sends this verification parameter to the EES to be used in the Nnef_UEId service invocation. The 3GPP network checks the correctness of this verification parameter for the IP address. In this manner, embodiments can prevent rogue or unauthorized UEs from obtaining UE identifiers for other UEs, which improves security in edge data networks.

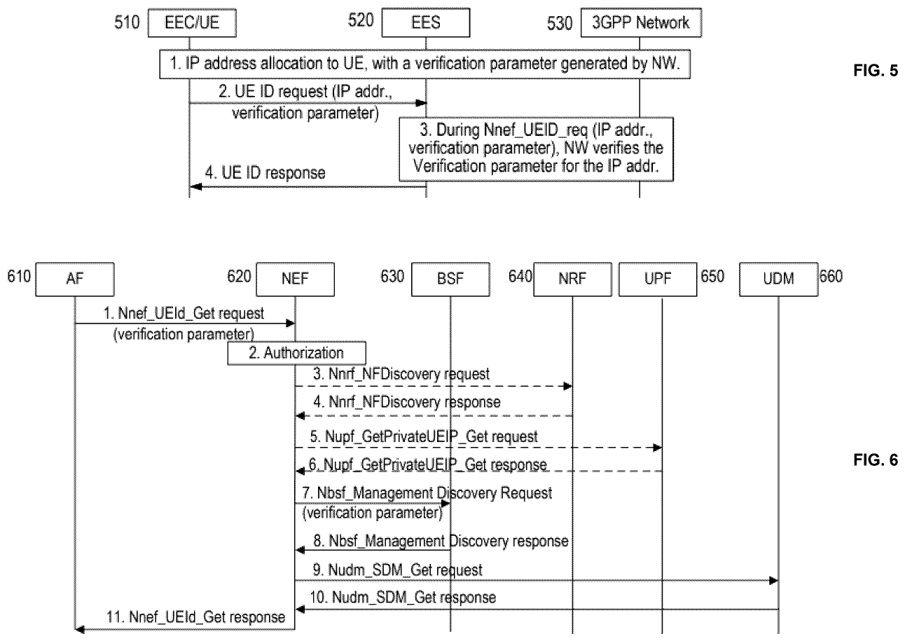

FIG. 5 shows a signaling diagram of a procedure for IP address verification between an EEC/UE (510), an EES (720), and a 3GPP network (530), according to some embodiments of the present disclosure. Although the operations in FIG. 5 are given numerical labels, this is done to facilitate explanation rather than to imply or require any operational order, unless stated to the contrary.

In operation 1, during PDU session establishment, the 3GPP network sends the UE an IP address verification parameter in addition to a private IP address and other related parameters. In operation 2, the EEC in the UE sends the verification parameter and the IP address to the EES. In operation 3, the EES invokes the Nnef_UEId Get service operation using the verification parameter and the IP address. In operation 3, the 3GPP network verifies the verification parameter for the IP address. If verification is successful, in operation 4 the 3GPP network provides the AF-specific GPSI to the EES.

In some embodiments, the IP address verification parameter can be a randomly generated nonce value. Alternately, this randomly generated value can be referred to as a “token”, “ticket”, etc. In other embodiments, the IP address verification parameter can be an output of a function that can take the IP address, a secret key, and optionally some additional parameters as inputs. An example function is a message authentication code (MAC) algorithm.

If the verification parameter is a nonce value, then the verification in FIG. 5 operation 3 is checking a mapping between the IP address and the nonce value. To be able to check the mapping, the 3GPP network needs to store the mapping during the IP address allocation in operation 1.

If the verification parameter is an output of a function, then the verification in FIG. 5 operation 3 is execution of a verification function. For example, if the function is a MAC algorithm, then the 3GPP network applies the same MAC algorithm with inputs of the IP address received from the EES, the secret key known by the 3GPP network, and optionally the additional parameters. The 3GPP network checks whether the MAC algorithm output is equal to the received verification parameter.

In various embodiments, the 3GPP network function generating the verification parameter (or function/inputs) during UE IP address allocation procedure (e.g., FIG. 5 operation 1) can be SMF or UPF. The verification parameter (or a function/inputs) is sent to PCF in an Npcf_SMPolicyControl_Create request. The PCF then stores the verification parameter (or a function/inputs) as part of PDU session binding information in BSF using an Nbsf_Management_Register request.

The BSF stores the binding information for a certain PDU Session; and discovers the selected PCF according to the binding information. The BSF allows PCFs to register, update and remove the binding information from it, and allows NF consumers to discover the selected PCF. The BSF can be deployed standalone or can be collocated with other network functions, such as PCF, UDR, NRF and SMF.

FIG. 6 shows a signaling diagram of a procedure for IP address verification performed within a 3GPP network, according to some embodiments of the present disclosure. In particular, the procedure shown in FIG. 6 is between an AF (610, e.g., EES), an NEF (620), a BSF (630), an NRF (640), a UPF (650), and a UDM (660). Although the operations in FIG. 6 are given numerical labels, this is done to facilitate explanation rather than to imply or require any operational order, unless stated to the contrary.

In operation 1, an AF requests to retrieve UE ID via the Nnef_UEId_Get service operation. The request includes a UE address (IP address or MAC address) and an AF Identifier. The request may also include machine type communication (MTC) Provider Information, Application Port ID, and IP domain. The MTC Provider Information identifies the MTC Service Provider and/or MTC Application. If available the AF may also provide the corresponding data network name (DNN) and/or Single Network Slice Selection Assistance Information (S-NSSAI).

For example, the MTC Provider Information can be used by any type of Service Providers (MTC or non-MTC) or Corporate or External Parties for, e.g. to distinguish their different customers. The NEF can validate the provided MTC Provider Information and override it to a NEF selected MTC Provider Information based on configuration. How the NEF determines the MTC Provider Information, if not present, is left to implementation (e.g. based on the requesting AF).

In operation 2, NEF authorizes the AF request. If the authorization is not granted, the NEF replies to the AF with a result value indicating authorization failure; otherwise the NEF proceeds with the following operations. The NEF determines corresponding DNN and/or S-NSSAI information: this may have been provided by the AF or is determined by the NEF based on the requesting AF Identifier and/or MTC Provider Information.

Operations 3-6 are optional. In operations 3-4, the NEF sends a Nnrf_NFDiscovery request to the NRF and receives an Nnrf_NFDiscovery response from the NRF. In operations 5-6, the NEF sends an Nupf_GetPrivateUEIP_Get request to the UPF and receives an Nupf_GetPrivateUEIP_Get response from the UPF.

In operations 7-8, the NEF uses the Nbsf_Management_Discovery service operation with UE address (e.g., IP) and IP domain and/or DNN and/or S-NSSAI to retrieve the session binding information of the UE. The NEF includes the verification parameter received in operation 1. If no SUPI is received in the session binding information from the BSF, the NEF replies to the AF with a result value indicating that the UE ID is not available. The BSF also performs the checking of the received verification parameter, e.g., using any of the techniques described above for various embodiments. For example, the BSF can based the verification on the verification parameter (or function/inputs) received from PCF during IP address allocation, as discussed above.

In operation 9, the NEF interacts with UDM to retrieve the AF specific UE identifier via the Nudm_SDM_Get service operation. The request message includes SUPI and at least one of Application Port ID, MTC Provider Information, and AF identifier. In operation 10, UDM responds to the NEF with an AF specific UE identifier represented as an external identifier for the UE (e.g., GPSI). This external identifier is uniquely associated with the application port ID, MTC provider information, and/or AF Identifier. In operation 11, NEF responds to the AF with the information received from the UDM, including the AF specific UE identifier represented as an external identifier (e.g., GPSI).

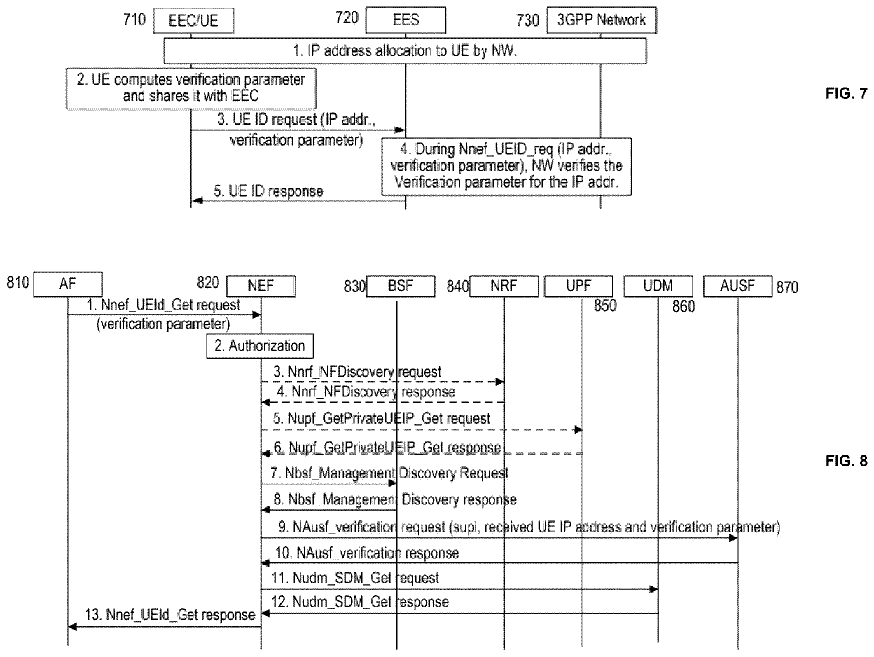

FIG. 7 shows a signaling diagram between an EEC/UE (710), an EES (720), and a 3GPP network (730) for IP address verification, according to other embodiments of the present disclosure. Although the operations in FIG. 7 are given numerical labels, this is done to facilitate explanation rather than to imply or require any operational order, unless stated to the contrary.

In operation 1, during PDU session establishment, the 3GPP network sends the UE a private IP address and other related parameters. In operation 2, the UE computes a verification parameter for the IP address using a secret key which is also known by the 3GPP network. For this computation, a MAC algorithm can be used. The key can be Kausf, which is known by the AUSF and ME, another key derived from Kausf directly or via one or more intermediate keys in the key hierarchy with Kausf as root. In the verification parameter computation, some other additional parameters can also be used.

In operation 3, the EEC in the UE invokes the Nnef_UEId Get service operation using the verification parameter computed in operation 2 and the IP address received in operation 1 to EES. In operation 4, the EES invokes the Nnef_UEId Get service operation using the received verification parameter and IP address. In operation 4, the 3GPP network verifies the verification parameter for the IP address. If verification is successful, in operation 5 the 3GPP network provides the AF-specific GPSI to the EES.

In some embodiments, the IP address verification parameter can be a randomly generated nonce value. Alternately, this randomly generated value can be referred to as a “token”, “ticket”, etc. In other embodiments, the IP address verification parameter can be an output of a function that can take the IP address, a secret key (e.g., Kausf or key derived therefrom), and optionally some additional parameters as inputs. An example function is a MAC algorithm.

If the verification parameter is a nonce value, then the verification in FIG. 7 operation 4 is checking a mapping between the IP address and the nonce value. To be able to check the mapping, the 3GPP network needs to store the mapping during the IP address allocation in operation 1.

If the verification parameter is an output of a function, then the verification in FIG. 7 operation 4 is execution of a verification function. For example, if the function is a MAC algorithm, then the 3GPP network applies the same MAC algorithm with inputs of the IP address received from the EES, the secret key known by the 3GPP network, and optionally the additional parameters. The 3GPP network checks whether the MAC algorithm output is equal to the received verification parameter.

FIG. 8 shows a signaling diagram of a procedure for IP address verification performed within a 3GPP network, according to other embodiments of the present disclosure. In particular, the procedure shown in FIG. 8 is between an AF (810, e.g., EES), an NEF (820), a BSF (830), an NRF (840), a UPF (850), a UDM (860), and an AUSF (870). Although the operations in FIG. 8 are given numerical labels, this is done to facilitate explanation rather than to imply or require any operational order, unless stated to the contrary.

Operations 1-6 are similar to operations 1-6 in FIG. 6, described above. In operations 7-8, the NEF uses the Nbsf_Management_Discovery service operation with UE address and IP domain and/or DNN and/or S-NSSAI to retrieve the session binding information of the UE. If no SUPI is received in the session binding information from the BSF, the NEF replies to the AF with a result value indicating that the UE ID is not available.

In operation 9, NEF sends SUPI (obtained in operation 8) and the UE IP address and verification parameter (obtained in operation 1) to AUSF using Nausf_verification request service operations. The AUSF performs the verification using Kausf or another key derived from Kausf, in a similar manner as the BSF in FIG. 6 discussed above. If verification is successful, the NEF continues with operations 11-13, which are substantially identical to operations 10-12 of FIG. 6.

In other embodiments, both the UE and the 3GPP network can generate and store the verification parameter (or function/inputs) during the IP address allocation procedure. For example, a key used for generating the verification parameter can be generated and stored in the UE and in the BSF, together with the PDU session binding information. For example, the AMF can generate the key for the verification using a Kamf key and then sends it to the SMF, which sends the key to PCF (e.g. via Npcf_SMPolicyControl_Create request), which then stores it in BSF (e.g. via Nbsf_Management_Register request) as part of PDU session binding information.

Later, during verification operations (e.g., FIG. 5 operation 3 or FIG. 6 operation 7), the NEF sends the received verification parameter to the BSF (e.g., using Nbsf_Management Discovery request) and the BSF performs the verification of the received parameter using the key that it previously stored.

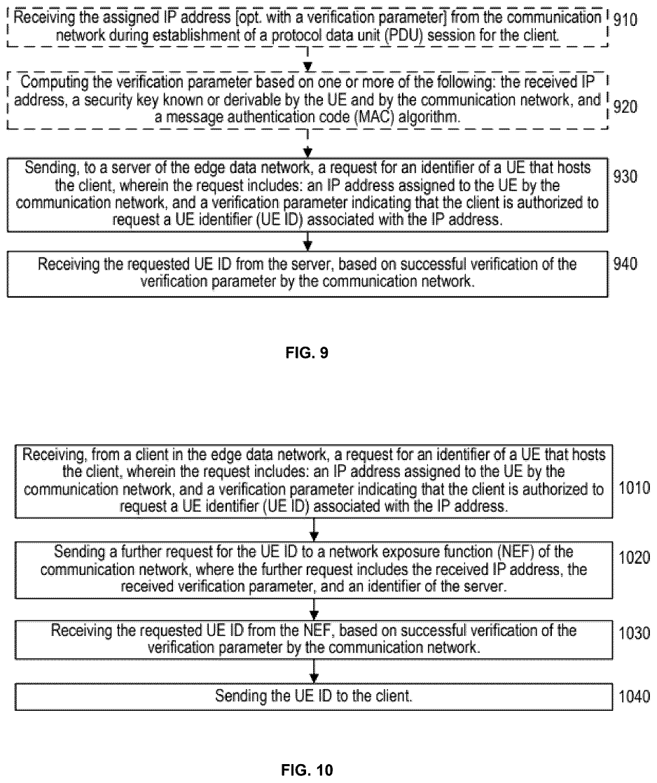

The embodiments described above can be further illustrated with reference to FIGS. 9-12, which depict exemplary methods (e.g., procedures) performed by a client in an edge data network, a server in the edge data network, an NEF, and a verification server in a communication network, respectively. Put differently, various features of the operations described below correspond to various embodiments described above. The exemplary methods shown in FIGS. 9-12 can be complementary to each other such that they can be used cooperatively to provide benefits, advantages, and/or solutions to problems described herein. Although the exemplary methods are illustrated in FIGS. 9-12 by specific blocks in particular orders, the operations corresponding to the blocks can be performed in different orders than shown and can be combined and/or divided into operations having different functionality than shown. Optional blocks and/or operations are indicated by dashed lines.

More specifically, FIG. 9 illustrates an exemplary method (e.g., procedure) for a client of an edge data network coupled to a communication network (e.g., 5G network), according to various embodiments of the present disclosure. The exemplary method shown in FIG. 9 can be performed by a client hosted by a UE (e.g., wireless device), such as an EEC described elsewhere herein.

The exemplary method can include the operations of block 930, where the client can send, to a server of the edge data network, a request for an identifier of a UE that hosts the client. The request includes an IP address assigned to the UE by the communication network and a verification parameter indicating that the client is authorized to request a UE identifier (UE ID) associated with the IP address. The exemplary method can also include the operations of block 940, where the client can subsequently receive the requested UE ID from the server, based on successful verification of the verification parameter by the communication network.

In some embodiments, the exemplary method can also include the operations of block 910, where the client can receive the assigned IP address from the communication network during establishment of a protocol data unit (PDU) session for the client. In some of these embodiments, the exemplary method can also include the operations of block 920, where the client can compute the verification parameter based on one or more of the following: the received IP address, a security key known or derivable by the UE and by the communication network, and a message authentication code (MAC) algorithm. FIG. 7 shows an example of these embodiments. In different variants of these embodiments, the security key can be any of the following: Kausf, a key directly or indirectly derivable from Kausf, Kamf, or a key directly or indirectly derivable from Kamf.

In other of these embodiments, the verification parameter is received from the communication network together with the assigned IP address. FIG. 5 shows an example of these embodiments. In some variants of these embodiments, the verification parameter is a randomly generated nonce value.

In some embodiments, the client is an EEC and the server is an EES. In some embodiments, the UE ID is a GPSI or an Edge UE ID.

In addition, FIG. 10 illustrates an exemplary method (e.g., procedure) for a server of an edge data network coupled to a communication network (e.g., 5G network), according to various embodiments of the present disclosure. The exemplary method shown in FIG. 10 can be performed by any appropriate server (e.g., EES, etc.) such as described elsewhere herein.

The exemplary method can include the operation of block 1010, where the server can receive, from a client in the edge data network, a request for an identifier of a UE that hosts the client. The request includes an IP address assigned to the UE by the communication network and a verification parameter indicating that the client is authorized to request a UE identifier (UE ID) associated with the IP address. The exemplary method can also include the operations of block 1020, where the server can send a further request for the UE ID to a network exposure function (NEF) of the communication network. The further request includes the received IP address, the received verification parameter, and an identifier of the server. The exemplary method can also include the operations of blocks 1030-1040, where the server can subsequently receive the requested UE ID from the NEF, based on successful verification of the verification parameter by the communication network, and send the UE ID to the client.

In some embodiments, the verification parameter is based on one or more of the following: the IP address, a security key known or derivable by the UE and by the communication network, and a message authentication code (MAC) algorithm. In different variants of these embodiments, the security key is one of the following: Kausf, a key directly or indirectly derivable from Kausf, Kamf, or a key directly or indirectly derivable from Kamf. In other embodiments, the verification parameter is a randomly generated nonce value.

In some embodiments, the client is an EEC and the server is an EES. In some embodiments, the UE ID is a GPSI or an Edge UE ID.

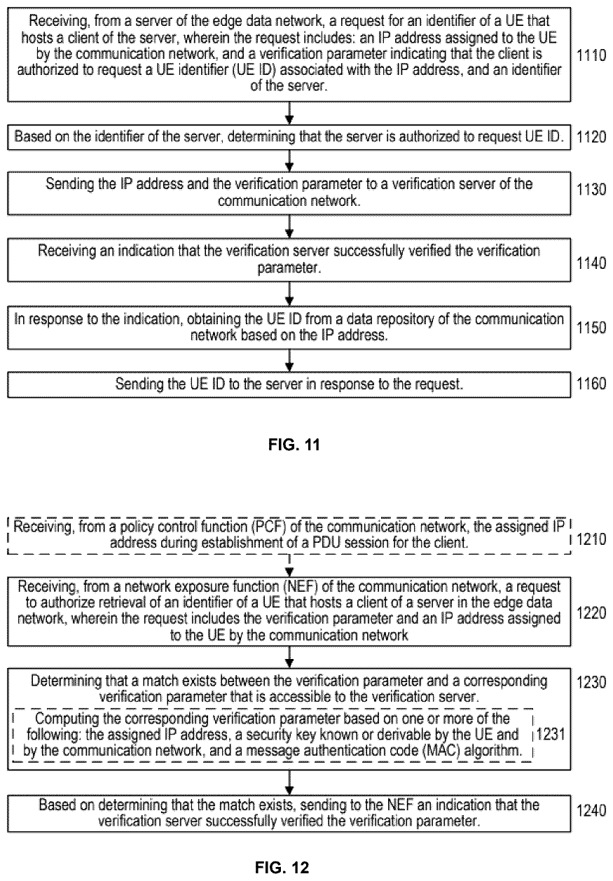

In addition, FIG. 11 illustrates an exemplary method (e.g., procedure) for a NEF of a communication network (e.g., 5GC) coupled to an edge data network, according to various embodiments of the present disclosure. The exemplary method shown in FIG. 11 can be performed by a NEF (or network node hosting the same) such as described elsewhere herein.

The exemplary method can include the operations of block 1110, where the NEF can receive, from a server of the edge data network, a request for an identifier of a UE that hosts a client of the server. The request includes an IP address assigned to the UE by the communication network, a verification parameter indicating that the client is authorized to request a UE identifier (UE ID) associated with the IP address, and an identifier of the server. The exemplary method can also include the operations of block 1120, where based on the identifier of the server, the NEF can determine that the server is authorized to request the UE ID.

The exemplary method can also include the operation of block 1130, where based on determining that the server is authorized, the NEF can send the IP address and the verification parameter to a verification server of the communication network. The exemplary method can also include the operation of blocks 1140-1150, where the NEF can receive an indication that the verification server successfully verified the verification parameter and in response to the indication, obtain the UE ID from a data repository of the communication network based on the IP address. The exemplary method can also include the operations of block 1160, where the NEF can send the UE ID to the server in response to the request.

In some embodiments, the verification parameter is based on one or more of the following: the IP address, a security key known or derivable by the UE and by the communication network, and a message authentication code (MAC) algorithm. In different variants of these embodiments, the security key is one of the following: Kausf, a key directly or indirectly derivable from Kausf, Kamf, or a key directly or indirectly derivable from Kamf. In other embodiments, the verification parameter is a randomly generated nonce value.

In some embodiments, the client is an EEC and the server is an EES. In some embodiments, the UE ID is a GPSI or an Edge UE ID. In some embodiments, the data repository is a unified data management function (UDM) of the communication network. In different embodiments, the verification server is a binding support (BSF, e.g., as shown in FIG. 6) or an authentication server function (AUSF, e.g., as shown in FIG. 8).

In addition, FIG. 12 illustrates an exemplary method (e.g., procedure) for a verification server of a communication network (e.g., 5GC) coupled to an edge data network, according to various embodiments of the present disclosure. The exemplary method shown in FIG. 12 can be performed by a verification server (e.g., BSF, AUSF, etc. or network node hosting the same) such as described elsewhere herein.

The exemplary method can include the operations of block 1220, where the verification server can receive, from an NEF of the communication network, a request to authorize retrieval of an identifier of a UE that hosts a client of a server in the edge data network. The request includes the verification parameter and an IP address assigned to the UE by the communication network. The exemplary method can also include the operations of block 1230, where the verification server can determine that a match exists between the verification parameter and a corresponding verification parameter that is accessible to the verification server. The exemplary method can also include the operations of block 1240, where based on determining that the match exists, the verification server can send to the NEF an indication that the verification server successfully verified the verification parameter.

In some embodiments, the exemplary method can also include the operations of block 1210, where the verification server can receive, from a policy control function (PCF) of the communication network, the assigned IP address during establishment of a PDU session for the client. In some of these embodiments, determining that a match exists between the verification parameter and a corresponding verification parameter in block 1230 includes the operations of sub-block 1231, where the verification server can compute the corresponding verification parameter based on one or more of the following: the assigned IP address, a security key known or derivable by the UE and by the communication network, and a message authentication code (MAC) algorithm.

In some variants of these embodiments, the security key is received from the PCF together with the assigned IP address. In some variants of these embodiments, the verification server is an AUSF and the security key is Kausf or a key directly or indirectly derivable from Kausf. FIG. 8 shows an example of these variants. In other variants of these embodiments, the verification server is a BSF and the security key is Kamf or a key directly or indirectly derivable from Kamf. FIG. 6 shows an example of these variants.

In other of these embodiments, the verification parameter is received from the communication network together with the assigned IP address. In some variants of these embodiments, the verification parameter is a randomly generated nonce value.

In some embodiments, the client is an EEC and the server is an EES. In some embodiments, the UE ID is a GPSI or an Edge UE ID.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

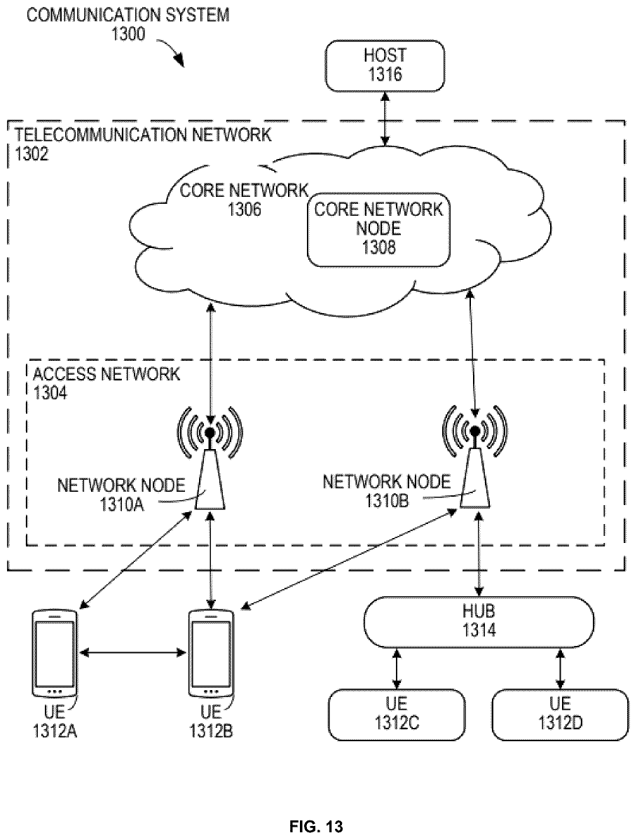

FIG. 13 shows an example of a communication system 1300 in accordance with some embodiments. In this example, communication system 1300 includes a telecommunication network 1302 that includes an access network 1304 (e.g., RAN) and a core network 1306, which includes one or more core network nodes 1308. Access network 1304 includes one or more access network nodes, such as network nodes 1310a-b (one or more of which may be generally referred to as network nodes 1310), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 1302 includes one or more Open-RAN (ORAN) network nodes. An ORAN network node is a node in telecommunication network 1302 that supports an ORAN specification (e.g., a specification published by the O-RAN Alliance, or any similar organization) and may operate alone or together with other nodes to implement one or more functionalities of any node in telecommunication network 1302, including one or more network nodes 1310 and/or core network nodes 1308.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 1310 facilitate direct or indirect connection of UEs, such as by connecting UEs 1312a-d (one or more of which may be generally referred to as UEs 1312) to core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1300 may include any number of wired or wireless networks, network nodes, UEs, and/or any other components or systems that may facilitate or participate in the communication of data and/or signals whether via wired or wireless connections. Communication system 1300 may include and/or interface with any type of communication, telecommunication, data, cellular, radio network, and/or other similar type of system.

UEs 1312 may be any of a wide variety of communication devices, including wireless devices arranged, configured, and/or operable to communicate wirelessly with network nodes 1310 and other communication devices. Similarly, network nodes 1310 are arranged, capable, configured, and/or operable to communicate directly or indirectly with UEs 1312 and/or with other network nodes or equipment in telecommunication network 1302 to enable and/or provide network access, such as wireless network access, and/or to perform other functions, such as administration in telecommunication network 1302.

In the depicted example, core network 1306 connects network nodes 1310 to one or more hosts, such as host 1316. These connections may be direct or indirect via one or more intermediary networks or devices. In other examples, network nodes may be directly coupled to hosts. Core network 1306 includes one or more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1316 may be under the ownership or control of a service provider other than an operator or provider of access network 1304 and/or telecommunication network 1302, and may be operated by the service provider or on behalf of the service provider. Host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1302 is a cellular network that implements 3GPP standardized features. Accordingly, telecommunication network 1302 may support network slicing to provide different logical networks to different devices that are connected to telecommunication network 1302. For example, telecommunication network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1312 are configured to transmit and/or receive information without direct human interaction. For instance, a UE may be designed to transmit information to access network 1304 on a predetermined schedule, when triggered by an internal or external event, or in response to requests from access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1314 communicates with access network 1304 to facilitate indirect communication between one or more UEs (e.g., UE 1312c and/or 1312d) and network nodes (e.g., network node 1310b). In some examples, hub 1314 may be a controller, router, content source and analytics, or any of the other communication devices described herein regarding UEs. For example, hub 1314 may be a broadband router enabling access to core network 1306 for the UEs. As another example, hub 1314 may be a controller that sends commands or instructions to one or more actuators in the UEs. Commands or instructions may be received from the UEs, network nodes 1310, or by executable code, script, process, or other instructions in hub 1314. As another example, hub 1314 may be a data collector that acts as temporary storage for UE data and, in some embodiments, may perform analysis or other processing of the data. As another example, hub 1314 may be a content source. For example, for a UE that is a VR headset, display, loudspeaker or other media delivery device, hub 1314 may retrieve VR assets, video, audio, or other media or data related to sensory information via a network node, which hub 1314 then provides to the UE either directly, after performing local processing, and/or after adding additional local content. In still another example, hub 1314 acts as a proxy server or orchestrator for the UEs, in particular if one or more of the UEs are low energy IoT devices.

Hub 1314 may have a constant/persistent or intermittent connection to network node 1310b. Hub 1314 may also allow for a different communication scheme and/or schedule between hub 1314 and UEs (e.g., UE 1312c and/or 1312d), and between hub 1314 and core network 1306. In other examples, hub 1314 is connected to core network 1306 and/or one or more UEs via a wired connection. Moreover, hub 1314 may be configured to connect to an M2M service provider over access network 1304 and/or to another UE over a direct connection. In some scenarios, UEs may establish a wireless connection with network nodes 1310 while still connected via hub 1314 via a wired or wireless connection. In some embodiments, hub 1314 may be a dedicated hub—that is, a hub whose primary function is to route communications to/from the UEs from/to network node 1310b. In other embodiments, hub 1314 may be a non-dedicated hub—that is, a device which is capable of operating to route communications between the UEs and network node 1310b, but which is additionally capable of operating as a communication start and/or end point for certain data channels.

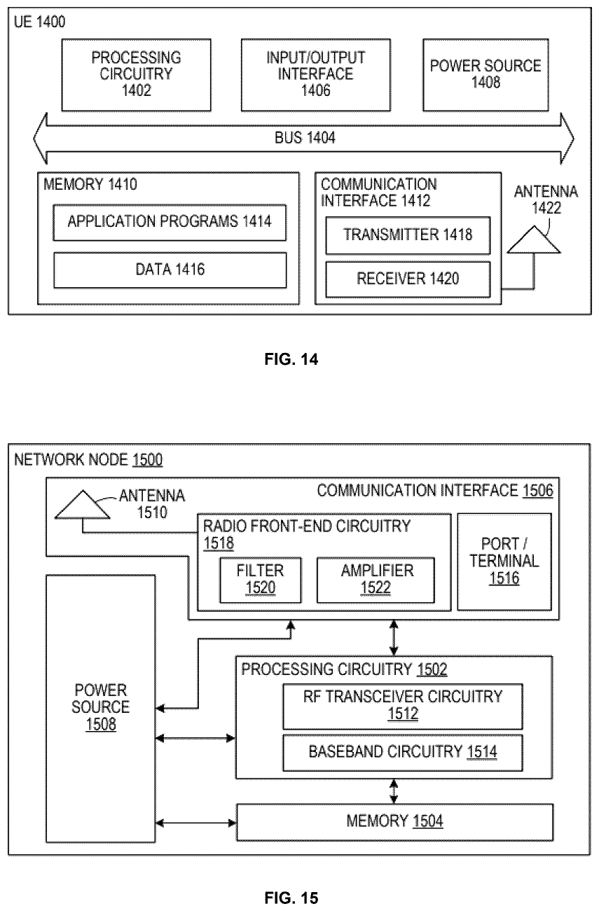

FIG. 14 shows a UE 1400 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

Processing circuitry 1402 is configured to process instructions and data and may be configured to implement any sequential state machine operative to execute instructions stored as machine-readable computer programs in memory 1410. Processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1402 may include multiple central processing units (CPUs).

In the example, input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1408 is structured as a battery or battery pack. Other types of power sources, such as an external power source (e.g., an electricity outlet), photovoltaic device, or power cell, may be used. Power source 1408 may further include power circuitry for delivering power from power source 1408 itself, and/or an external power source, to the various parts of UE 1400 via input circuitry or an interface such as an electrical power cable. Delivering power may be, for example, for charging of power source 1408. Power circuitry may perform any formatting, converting, or other modification to the power from power source 1408 to make the power suitable for the respective components of UE 1400 to which power is supplied.

Memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1410 includes one or more application programs 1414, such as an operating system, web browser application, a widget, gadget engine, or other application, and corresponding data 1416. Memory 1410 may store, for use by UE 1400, any of a variety of various operating systems or combinations of operating systems.

Memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1410 may allow UE 1400 to access instructions, application programs and the like, stored on transitory or non-transitory memory media, to off-load data, or to upload data. An article of manufacture, such as one utilizing a communication system may be tangibly embodied as or in memory 1410, which may be or comprise a device-readable storage medium.

Processing circuitry 1402 may be configured to communicate with an access network or other network using communication interface 1412. Communication interface 1412 may comprise one or more communication subsystems and may include or be communicatively coupled to an antenna 1422. Communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, transmitter 1418 and receiver 1420 may be coupled to one or more antennas (e.g., antenna 1422) and may share circuit components, software or firmware, or alternatively be implemented separately.

In the illustrated embodiment, communication functions of communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1500 includes a processing circuitry 1502, a memory 1504, a communication interface 1506, and a power source 1508. Network node 1500 may be composed of multiple physically separate components (e.g., a NodeB component and a RNC component, or a BTS component and a BSC component, etc.), which may each have their own respective components. In certain scenarios in which network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). Network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, RF transceiver circuitry 1512 and baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

Memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. Memory 1504 may store any suitable instructions, data, or information, including a computer program, software, an application including one or more of logic, rules, code, tables, and/or other instructions (collected denoted computer program 1504a, which may be in the form of a computer program product) capable of being executed by the processing circuitry 1502 and utilized by network node 1500. Memory 1504 may be used to store any calculations made by the processing circuitry 1502 and/or any data received via communication interface 1506. In some embodiments, the processing circuitry 1502 and memory 1504 is integrated.

Communication interface 1506 is used in wired or wireless communication of signaling and/or data between a network node, access network, and/or UE. As illustrated, communication interface 1506 comprises port(s)/terminal(s) 1516 to send and receive data, for example to and from a network over a wired connection. Communication interface 1506 also includes radio front-end circuitry 1518 that may be coupled to, or in certain embodiments a part of, antenna 1510. Radio front-end circuitry 1518 comprises filters 1520 and amplifiers 1522. Radio front-end circuitry 1518 may be connected to an antenna 1510 and processing circuitry 1502. The radio front-end circuitry may be configured to condition signals communicated between antenna 1510 and processing circuitry 1502. Radio front-end circuitry 1518 may receive digital data that is to be sent out to other network nodes or UEs via a wireless connection. Radio front-end circuitry 1518 may convert the digital data into a radio signal having the appropriate channel and bandwidth parameters using a combination of filters 1520 and/or amplifiers 1522. The radio signal may then be transmitted via antenna 1510. Similarly, when receiving data, antenna 1510 may collect radio signals which are then converted into digital data by radio front-end circuitry 1518. The digital data may be passed to the processing circuitry 1502. In other embodiments, the communication interface may comprise different components and/or different combinations of components.

In certain alternative embodiments, network node 1500 does not include separate radio front-end circuitry 1518, instead, the processing circuitry 1502 includes radio front-end circuitry and is connected to antenna 1510. Similarly, in some embodiments, all or some of RF transceiver circuitry 1512 is part of communication interface 1506. In still other embodiments, communication interface 1506 includes one or more ports or terminals 1516, radio front-end circuitry 1518, and RF transceiver circuitry 1512, as part of a radio unit (not shown), and communication interface 1506 communicates with baseband processing circuitry 1514, which is part of a digital unit (not shown).

Antenna 1510 may include one or more antennas, or antenna arrays, configured to send and/or receive wireless signals. Antenna 1510 may be coupled to radio front-end circuitry 1518 and may be any type of antenna capable of transmitting and receiving data and/or signals wirelessly. In certain embodiments, antenna 1510 is separate from network node 1500 and connectable to network node 1500 through an interface or port.

Antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, antenna 1510, communication interface 1506, and/or the processing circuitry 1502 may be configured to perform any transmitting operations described herein as being performed by the network node. Any information, data and/or signals may be transmitted to a UE, another network node and/or any other network equipment.

Power source 1508 provides power to the various components of network node 1500 in a form suitable for the respective components (e.g., at a voltage and current level needed for each respective component). Power source 1508 may further comprise, or be coupled to, power management circuitry to supply the components of network node 1500 with power for performing the functionality described herein. For example, network node 1500 may be connectable to an external power source (e.g., the power grid, an electricity outlet) via an input circuitry or interface such as an electrical cable, whereby the external power source supplies power to power circuitry of power source 1508. As a further example, power source 1508 may comprise a source of power in the form of a battery or battery pack which is connected to, or integrated in, power circuitry. The battery may provide backup power should the external power source fail.

Embodiments of network node 1500 may include additional components beyond those shown in FIG. 15 for providing certain aspects of the network node's functionality, including any of the functionality described herein and/or any functionality necessary to support the subject matter described herein. For example, network node 1500 may include user interface equipment to allow input of information into network node 1500 and to allow output of information from network node 1500. This may allow a user to perform diagnostic, maintenance, repair, and other administrative functions for network node 1500.

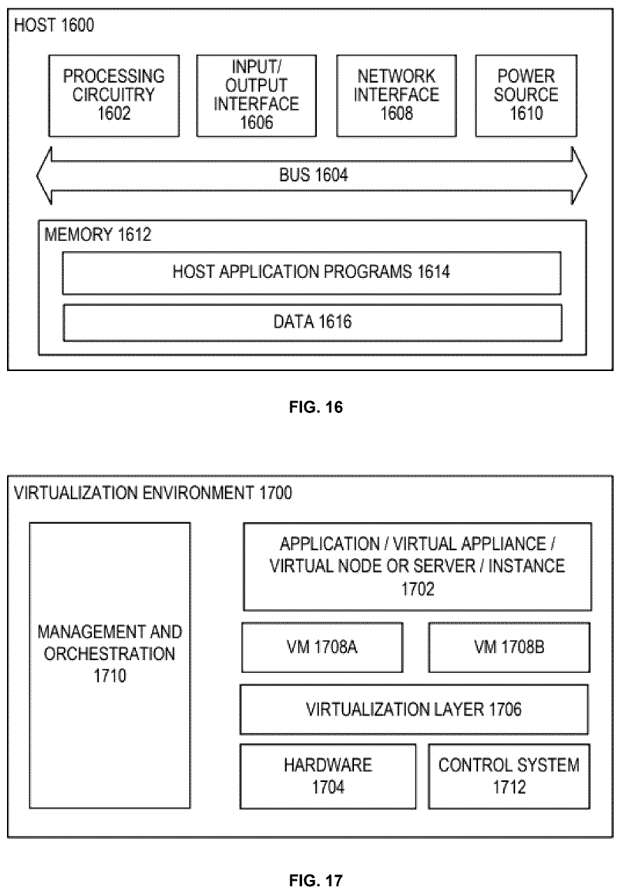

FIG. 16 is a block diagram of a host 1600, which may be an embodiment of host 1316 of FIG. 13, in accordance with various aspects described herein. As used herein, host 1600 may be or comprise various combinations hardware and/or software, including a standalone server, a blade server, a cloud-implemented server, a distributed server, a virtual machine, container, or processing resources in a server farm. Host 1600 may provide one or more services to one or more UEs.

Host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

Memory 1612 may include one or more computer programs including one or more host application programs 1614 and data 1616, which may include user data, e.g., data generated by a UE for host 1600 or data generated by host 1600 for a UE. Embodiments of host 1600 may utilize only a subset or all of the components shown. Host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1614 may also provide for user authentication and licensing checks and may periodically report health, routes, and content availability to a central node, such as a device in or on the edge of a core network. Accordingly, host 1600 may select and/or indicate a different host for over-the-top services for a UE. Host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1700 includes components defined by the O-RAN Alliance, such as an O-Cloud environment orchestrated by a Service Management and Orchestration Framework via an O-2 interface.

Applications 1702 (which may alternatively be called software instances, virtual appliances, network functions, virtual nodes, virtual network functions, etc.) are run in the virtualization environment 1700 to implement some of the features, functions, and/or benefits of some of the embodiments disclosed herein.

Hardware 1704 includes processing circuitry, memory that stores software and/or instructions (collected denoted computer program 1704a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. Virtualization layer 1706 may present a virtual operating platform that appears like networking hardware to the VMs 1708.

VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1708 may be a software implementation of a physical machine that runs programs as if they were executing on a physical, non-virtualized machine. Each VM 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration function 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

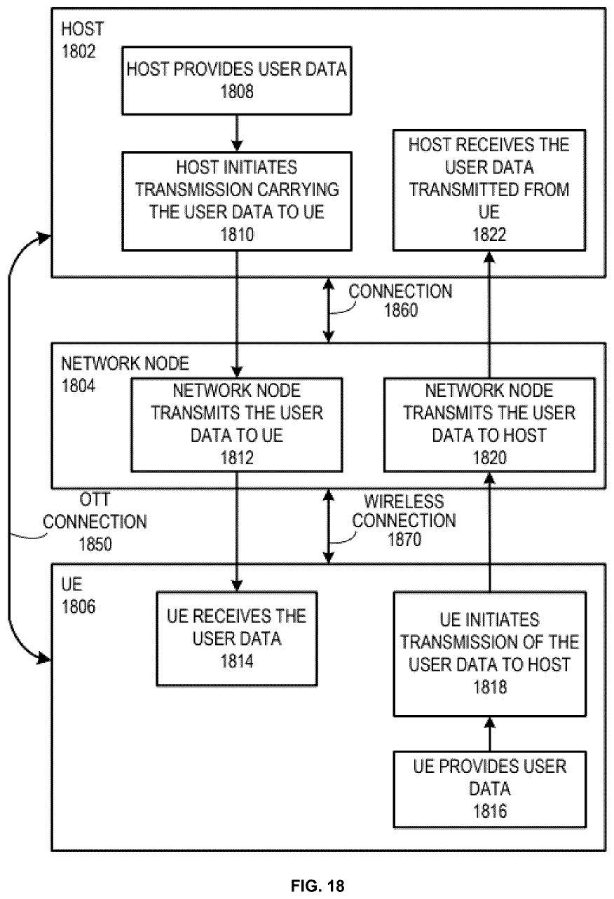

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. Host 1802 also includes software, which is stored in or accessible by host 1802 and executable by the processing circuitry. The software includes a host application that may be operable to provide a service to a remote user, such as UE 1806 connecting via an over-the-top (OTT) connection 1850 extending between UE 1806 and host 1802. In providing the service to the remote user, a host application may provide user data which is transmitted using OTT connection 1850.

Network node 1804 includes hardware enabling it to communicate with host 1802 and UE 1806. Connection 1860 may be direct or pass through a core network (like core network 1306 of FIG. 13) and/or one or more other intermediate networks, such as one or more public, private, or hosted networks. For example, an intermediate network may be a backbone network or the Internet.

UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of host 1802. In host 1802, an executing host application may communicate with the executing client application via OTT connection 1850 terminating at UE 1806 and host 1802. In providing the service to the user, the UE's client application may receive request data from the host's host application and provide user data in response to the request data. OTT connection 1850 may transfer both the request data and the user data. The UE's client application may interact with the user to generate the user data that it provides to the host application through OTT connection 1850.

OTT connection 1850 may extend via a connection 1860 between host 1802 and network node 1804 and via a wireless connection 1870 between network node 1804 and UE 1806 to provide the connection between host 1802 and UE 1806. Connection 1860 and wireless connection 1870, over which OTT connection 1850 may be provided, have been drawn abstractly to illustrate the communication between host 1802 and UE 1806 via network node 1804, without explicit reference to any intermediary devices and the precise routing of messages via these devices.

As an example of transmitting data via OTT connection 1850, in step 1808, host 1802 provides user data, which may be performed by executing a host application. In some embodiments, the user data is associated with a particular human user interacting with UE 1806. In other embodiments, the user data is associated with a UE 1806 that shares data with host 1802 without explicit human interaction. In step 1810, host 1802 initiates a transmission carrying the user data towards UE 1806. Host 1802 may initiate the transmission responsive to a request transmitted by UE 1806. The request may be caused by human interaction with UE 1806 or by operation of the client application executing on UE 1806. The transmission may pass via network node 1804, in accordance with the teachings of the embodiments described throughout this disclosure. Accordingly, in step 1812, network node 1804 transmits to UE 1806 the user data that was carried in the transmission that host 1802 initiated, in accordance with the teachings of the embodiments described throughout this disclosure. In step 1814, UE 1806 receives the user data carried in the transmission, which may be performed by a client application executed on UE 1806 associated with the host application executed by host 1802.

In some examples, UE 1806 executes a client application which provides user data to host 1802. The user data may be provided in reaction or response to the data received from host 1802. Accordingly, in step 1816, UE 1806 may provide user data, which may be performed by executing the client application. In providing the user data, the client application may further consider user input received from the user via an input/output interface of UE 1806. Regardless of the specific manner in which the user data was provided, UE 1806 initiates, in step 1818, transmission of the user data towards host 1802 via network node 1804. In step 1820, in accordance with the teachings of the embodiments described throughout this disclosure, network node 1804 receives user data from UE 1806 and initiates transmission of the received user data towards host 1802. In step 1822, host 1802 receives the user data carried in the transmission initiated by UE 1806.

One or more of the various embodiments improve the performance of OTT services provided to UE 1806 using OTT connection 1850, in which wireless connection 1870 forms the last segment. More precisely, embodiments described herein can prevent rogue or unauthorized UEs from obtaining UE identifiers for other UEs, which improves security in edge data networks coupled to 3GPP networks (e.g., 5GC and NG-RAN). When edge computing deployed in this manner is used to provide and/or support OTT data services, it increases the value of such services to end users and service providers

In an example scenario, factory status information may be collected and analyzed by host 1802. As another example, host 1802 may process audio and video data which may have been retrieved from a UE for use in creating maps. As another example, host 1802 may collect and analyze real-time data to assist in controlling vehicle congestion (e.g., controlling traffic lights). As another example, host 1802 may store surveillance video uploaded by a UE. As another example, host 1802 may store or control access to media content such as video, audio, VR or AR which it can broadcast, multicast or unicast to UEs. As other examples, host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1850 between host 1802 and UE 1806, in response to variations in the measurement results. The measurement procedure and/or the network functionality for reconfiguring the OTT connection may be implemented in software and hardware of host 1802 and/or UE 1806. In some embodiments, sensors (not shown) may be deployed in or in association with other devices through which OTT connection 1850 passes; the sensors may participate in the measurement procedure by supplying values of the monitored quantities exemplified above, or supplying values of other physical quantities from which software may compute or estimate the monitored quantities. The reconfiguring of OTT connection 1850 may include message format, retransmission settings, preferred routing etc.; the reconfiguring need not directly alter the operation of network node 1804. Such procedures and functionalities may be known and practiced in the art. In certain embodiments, measurements may involve proprietary UE signaling that facilitates measurements of throughput, propagation times, latency and the like, by host 1802. The measurements may be implemented in that software causes messages to be transmitted, in particular empty or ‘dummy’ messages, using OTT connection 1850 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Other embodiments are discussed in 3GPP TR 33.739 under Solution #28 on usage of randomly generated ticket to verify EEC provided IP address.
6.X Solution #X: Usage of ramdomly generated ticket to verify EEC provided IP address

### 6.X.1 Solution Overview

This solution is for the key issue on EEC provided IP address verification. Since the core network assigned IP addresses are guessable values, a compromised EEC can spoof the IP address to learn the identifier of another UE. To prevent such attacks, this solution proposes to use a non-guessable parameter called ticket or nonce provided by the core network to the EEC and to check the mapping between the IP address and the ticket value in the UE ID API invocation.

### 6.X.2 Solution Details

High-level overview of the solution is presented in FIG. 6.X.2-1 and steps are explained in detail below.

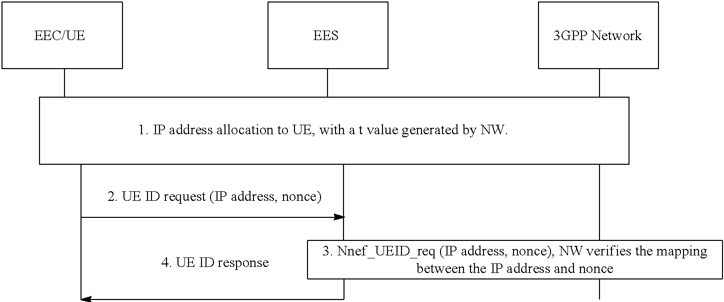

### FIG. 6.X.2-1: EEC Provided IP Address Verification

Step 1: In the PDU session establishment, the SMF/UPF generates a random ticket value during UE IP address allocation procedure, the ticket value is sent to the PCF, and then stored in the BSF as part of the PDU session binding information. The ticket value in addition to the private IP address is sent to the UE.
Step 2: The EEC in the UE sends the ticket value and the IP address to the EES.
Step 3: The EES invokes the Nnef_UEId GET service operation using the ticket value and the IP address. The NEF sends the received ticket value to the BSF (Binding Support Function specified in TS 23.501) in Nbsf_Management_Discovery service operation and the BSF performs the verification by checking the mapping between the ticket value and the IP address. If the verification is successful, then the NEF provides the AF specific GPSI to the EES.
   NOTE: If the BSF cannot find a binding information having both requested IP address and ticket, it implies that the verification fails.
Step 4: The EES sends the response to the EEC.

### 6.X.3 Solution Evaluation

This solution addresses the potential security requirements with less impact on the network functions. The SMF will only need to generate a random ticket and send it to the UE and BSF, without needing to store any parameter.

Embodiments of the techniques and apparatus described herein also include, but are not limited to, the following enumerated examples:

A1. A method for a client of an edge data network coupled to a communication network, the method comprising:
sending, to a server of the edge data network, a request for an identifier of a user equipment (UE) that hosts the client, wherein the request includes:
   an Internet Protocol (IP) address assigned to the UE by the communication network, and
   a verification parameter indicating that the client is authorized to request a UE identifier (UE ID) associated with the IP address; and
subsequently receiving the requested UE ID from the server, based on successful verification of the verification parameter by the communication network.

A2. The method of embodiment A1, further comprising receiving the assigned IP address from the communication network during establishment of a protocol data unit (PDU) session for the client.

A3. The method of embodiment A2, further comprising computing the verification parameter based on one or more of the following:
the received IP address;
a security key known or derivable by the UE and by the communication network; and
a message authentication code (MAC) algorithm.

A4. The method of embodiment A3, wherein the security key is one of the following: Kausf, a key directly or indirectly derivable from Kausf, Kamf, or a key directly or indirectly derivable from Kamf.

A5. The method of embodiment A2, wherein the verification parameter is received from the communication network together with the assigned IP address.

A6. The method of embodiment A5, wherein the verification parameter is a randomly generated nonce value.

A7. The method of any of embodiment A1-A6, wherein the client is an Edge Enabler Client (EEC) and the server is an Edge Enabler Server (EES).

A8. The method of any of embodiments A1-A7, wherein the UE ID is a generic public subscription identifier (GPSI).

B1. A method for a server of an edge data network coupled to a communication network, the method comprising:
receiving, from a client in the edge data network, a request for an identifier of a user equipment (UE) that hosts the client, wherein the request includes:
   an Internet Protocol (IP) address assigned to the UE by the communication network, and
   a verification parameter indicating that the client is authorized to request a UE identifier (UE ID) associated with the IP address;
sending a further request for the UE ID to a network exposure function (NEF) of the communication network, wherein the further request includes the received IP address, the received verification parameter, and an identifier of the server;
subsequently receiving the requested UE ID from the NEF, based on successful verification of the verification parameter by the communication network; and
sending the UE ID to the client.

B2. The method of embodiment B1, wherein the verification parameter is based on one or more of the following:
the IP address;
a security key known or derivable by the UE and by the communication network; and
a message authentication code (MAC) algorithm.

B3. The method of embodiment B2, wherein the security key is one of the following: Kausf, a key directly or indirectly derivable from Kausf, Kamf, or a key directly or indirectly derivable from Kamf.

B4. The method of embodiment B1, wherein the verification parameter is a randomly generated nonce value.

B5. The method of any of embodiment B1-B4, wherein the client is an Edge Enabler Client (EEC) and the server is an Edge Enabler Server (EES).

B6. The method of any of embodiments B1-B5, wherein the UE ID is a generic public subscription identifier (GPSI).

C1. A method for a network exposure function (NEF) of a communication network coupled to an edge data network, the method comprising:
receiving, from a server of the edge data network, a request for an identifier of a user equipment (UE) that hosts a client of the server, wherein the request includes:
   an Internet Protocol (IP) address assigned to the UE by the communication network,
   a verification parameter indicating that the client is authorized to request a UE identifier (UE ID) associated with the IP address, and
   an identifier of the server;
based on the identifier of the server, determining that the server is authorized to request the UE ID;
based on determining that the server is authorized, sending the IP address and the verification parameter to a verification server of the communication network; and
receiving an indication that the verification server successfully verified the verification parameter;
in response to the indication, obtaining the UE ID from a data repository of the communication network based on the IP address; and
sending the UE ID to the server in response to the request.

C2. The method of embodiment C1, wherein the verification parameter is based on one or more of the following:
the IP address;
a security key known or derivable by the UE and by the communication network; and
a message authentication code (MAC) algorithm.

C3. The method of embodiment C2, wherein the security key is one of the following: Kausf, a key directly or indirectly derivable from Kausf, Kamf, or a key directly or indirectly derivable from Kamf.

C4. The method of embodiment C1, wherein the verification parameter is a randomly generated nonce value.

C5. The method of any of embodiment C1-C4, wherein the client is an Edge Enabler Client (EEC) and the server is an Edge Enabler Server (EES).

C6. The method of any of embodiments C1-C5, wherein the UE ID is a generic public subscription identifier (GPSI).

C7. The method of any of embodiments C1-C6, wherein the data repository is a unified data management function (UDM) of the communication network.

C8. The method of any of embodiments C1-C7, wherein the verification server is one of the following: a bootstrapping function (BSF), or an authentication server function (AUSF).

D1. A method for a verification server of a communication network coupled to an edge data network, the method comprising:
receiving, from a network exposure function (NEF) of the communication network, a request to authorize retrieval of an identifier of a user equipment (UE) that hosts a client of a server in the edge data network, wherein the request includes the verification parameter and an Internet Protocol (IP) address assigned to the UE by the communication network;
determining that a match exists between the verification parameter and a corresponding verification parameter that is accessible to the verification server; and
based on determining that the match exists, sending to the NEF an indication that the verification server successfully verified the verification parameter.

D2. The method of embodiment D1, further comprising receiving, from a policy control function (PCF) of the communication network, the assigned IP address during establishment of a protocol data unit (PDU) session for the client.

D3. The method of embodiment D2, wherein determining that a match exists between the verification parameter and a corresponding verification parameter comprises computing the corresponding verification parameter based on one or more of the following:
the assigned IP address;
a security key known or derivable by the UE and by the communication network; and
a message authentication code (MAC) algorithm.

D4. The method of embodiment D3, wherein the security key is received from the PCF together with the assigned IP address.

D5. The method of any of embodiments D3-D4, wherein the verification server is an authentication server function (AUSF) and the security key is one of the following: Kausf, a key directly or indirectly derivable from Kausf.

D6. The method of any of embodiments D3-D4, wherein the verification server is a bootstrapping function (BSF) and the security key is one of the following: Kamf, or a key directly or indirectly derivable from Kamf.

D7. The method of embodiment D2, wherein the verification parameter is received from the communication network together with the assigned IP address.

D8. The method of embodiment D7, wherein the verification parameter is a randomly generated nonce value.

D9. The method of any of embodiments D1-D7, wherein the client is an Edge Enabler Client (EEC) and the server is an Edge Enabler Server (EES).

D10. The method of any of embodiments D1-D9, wherein the UE ID is a generic public subscription identifier (GPSI).

E1. A user equipment (UE) configured to host a client of an edge data network coupled to a communication network, the UE comprising:
communication interface circuitry configured to facilitate communication between the client and a server of the edge data network, and between the UE and the communication network; and
processing circuitry operably coupled to the communication interface circuitry, whereby the processing circuitry and communication interface circuitry are configured to perform operations corresponding to any of the methods of embodiments A1-A8.

E2. A user equipment (UE) configured to host a client of an edge data network coupled to a communication network, the UE being configured to perform operations corresponding to any of the methods of embodiments A1-A8.

E3. A non-transitory, computer-readable medium storing computer-executable instructions that, when executed by processing circuitry associated with a client of an edge data network coupled to a communication network, configure the client to perform operations corresponding to any of the methods of embodiments A1-A8.

E4. A computer program product comprising computer-executable instructions that, when executed by processing circuitry associated with a client of an edge data network coupled to a communication network, configure the client to perform operations corresponding to any of the methods of embodiments A1-A8.

F1. A server configured to operate in an edge data network coupled to a communication network, the server comprising:
communication interface circuitry configured to communicate with one or more clients of the edge data network and with the communication network; and
processing circuitry operably coupled to the interface circuitry, whereby the processing circuitry and the communication interface circuitry are configured to perform operations corresponding to any of the methods of embodiments B1-B6.

F2. A server configured to operate in an edge data network coupled to a communication network, the server being further configured to perform operations corresponding to any of the methods of embodiments B1-B6.

F3. A non-transitory, computer-readable medium storing computer-executable instructions that, when executed by processing circuitry associated with a server configured to operate in an edge data network coupled to a communication network, configure the server to perform operations corresponding to any of the methods of embodiments B1-B6.

F4. A computer program product comprising computer-executable instructions that, when executed by processing circuitry associated with a server configured to operate in an edge data network coupled to a communication network, configure the server to perform operations corresponding to any of the methods of embodiments B1-B6.

G1. A network exposure function (NEF) configured to operate in a communication network coupled to an edge data network, the NEF comprising:
communication interface circuitry configured to communicate with a server of the edge data network and with a verification server of the communication network; and
processing circuitry operably coupled to the interface circuitry, whereby the processing circuitry and the communication interface circuitry are configured to perform operations corresponding to any of the methods of embodiments C1-C8.

G2. A network exposure function (NEF) configured to operate in a communication network coupled to an edge data network, the NEF being further configured to perform operations corresponding to any of the methods of embodiments C1-C8.

G3. A non-transitory, computer-readable medium storing computer-executable instructions that, when executed by processing circuitry associated with a network exposure function (NEF) configured to operate in a communication network coupled to an edge data network, configure the NEF to perform operations corresponding to any of the methods of embodiments C1-C8.

G4. A computer program product comprising computer-executable instructions that, when executed by processing circuitry associated with a network exposure function (NEF) configured to operate in a communication network coupled to an edge data network, configure the NEF to perform operations corresponding to any of the methods of embodiments C1-C8.

H1. A verification server configured to operate in a communication network coupled to an edge data network, the verification server comprising:
communication interface circuitry configured to communicate with at least a network exposure function (NEF) of the communication network; and
processing circuitry operably coupled to the interface circuitry, whereby the processing circuitry and the communication interface circuitry are configured to perform operations corresponding to any of the methods of embodiments D1-D10.

H2. A verification server configured to operate in a communication network coupled to an edge data network, the verification server being further configured to perform operations corresponding to any of the methods of embodiments D1-D10.

H3. A non-transitory, computer-readable medium storing computer-executable instructions that, when executed by processing circuitry associated with a verification server configured to operate in a communication network coupled to an edge data network, configure the NEF to perform operations corresponding to any of the methods of embodiments D1-D10.

H4. A computer program product comprising computer-executable instructions that, when executed by processing circuitry associated with a verification server configured to operate in a communication network coupled to an edge data network, configure the NEF to perform operations corresponding to any of the methods of embodiments D1-D10.

1. A method for a client of an edge data network coupled to a communication network, the method comprising:
sending, to a server of the edge data network, a request for an identifier of a user equipment, UE, that hosts the client, wherein the request includes:
an Internet Protocol, IP, address assigned to the UE by the communication network, and
a verification parameter indicating that the client is authorized to request a UE identifier, UE ID, associated with the IP address; and
subsequently receiving the requested UE ID from the server, based on successful verification of the verification parameter by the communication network.

2. The method of claim 1, further comprising receiving the assigned IP address from the communication network during establishment of a protocol data unit, PDU, session for the client.

3. The method of claim 2, further comprising computing the verification parameter based on one or more of the following:
the received IP address;
a security key known or derivable by the UE and by the communication network; and
a message authentication code, MAC, algorithm.

4. The method of claim 3, wherein the security key is one of the following: Kausf, a key directly or indirectly derivable from Kausf, Kamf, or a key directly or indirectly derivable from Kamf.

5. The method of claim 2, wherein the verification parameter is received from the communication network together with the assigned IP address.

6. The method of claim 5, wherein the verification parameter is a randomly generated nonce value.

7. The method of claim 1, wherein the client is an Edge Enabler Client, EEC, and the server is an Edge Enabler Server, EES.

8. The method of claim 1, wherein the UE ID is a generic public subscription identifier, GPSI or an Edge UE ID.

9. A method for a server of an edge data network coupled to a communication network, the method comprising:
receiving, from a client in the edge data network, a request for an identifier of a user equipment, UE, that hosts the client, wherein the request includes:
an Internet Protocol, IP, address assigned to the UE by the communication network, and
a verification parameter indicating that the client is authorized to request a UE identifier, UE ID, associated with the IP address;
sending a further request for the UE ID to a network exposure function, NEF, of the communication network, wherein the further request includes the received IP address, the received verification parameter, and an identifier of the server;
subsequently receiving the requested UE ID from the NEF, based on successful verification of the verification parameter by the communication network; and
sending the UE ID to the client.

10. The method of claim 9, wherein the verification parameter is based on one or more of the following:
the IP address;
a security key known or derivable by the UE and by the communication network; and
a message authentication code, MAC, algorithm.

11. The method of claim 10, wherein the security key is one of the following: Kausf, a key directly or indirectly derivable from Kausf, Kamf, or a key directly or indirectly derivable from Kamf.

12. The method of claim 9, wherein the verification parameter is a randomly generated nonce value.

13. The method of claim 9, wherein the client is an Edge Enabler Client, EEC, and the server is an Edge Enabler Server, EES.

14. The method of claim 9, wherein the UE ID is a generic public subscription identifier, GPSI or an Edge UE ID.

15. A method for a network exposure function, NEF, of a communication network coupled to an edge data network, the method comprising:
receiving, from a server of the edge data network, a request for an identifier of a user equipment, UE, that hosts a client of the server, wherein the request includes:
An Internet Protocol, IP, address assigned to the UE by the communication network,
a verification parameter indicating that the client is authorized to request a UE identifier, UE ID, associated with the IP address, and
an identifier of the server;
based on the identifier of the server, determining that the server is authorized to request the UE ID;
based on determining that the server is authorized, sending the IP address and the verification parameter to a verification server of the communication network; and
receiving an indication that the verification server successfully verified the verification parameter;
in response to the indication, obtaining the UE ID from a data repository of the communication network based on the IP address; and
sending the UE ID to the server in response to the request.

16. The method of claim 15, wherein the verification parameter is based on one or more of the following:
the IP address;
a security key known or derivable by the UE and by the communication network; and
a message authentication code, MAC, algorithm.

17. The method of claim 16, wherein the security key is one of the following: Kausf, a key directly or indirectly derivable from Kausf, Kamf, or a key directly or indirectly derivable from Kamf.

18. The method of claim 15, wherein the verification parameter is a randomly generated nonce value.

19. The method of claim 15, wherein the client is an Edge Enabler Client, EEC, and the server is an Edge Enabler Server, EES.

20. The method of claim 15, wherein the UE ID is a generic public subscription identifier, GPSI or an Edge UE ID.

21-48. (canceled)
